(19) United States
(12) Patent Application Publication
(10) Pub. No.: US 2006/0191884 A1
(43) Pub. Date: Aug. 31, 2006

(54) High-speed, precise, laser-based material processing method and system

(76) Inventors: Shepard D. Johnson, Andover, MA (US); Bo Gu, North Andover, MA (US); James J. Cordingley, Littleton, MA (US)

Correspondence Address: BROOKS KUSHMAN P.C., 1000 TOWN CENTER, TWENTY-SECOND FLOOR, SOUTHFIELD, MI, 48075, US

(21) Appl. No.: 11/334,118

(22) Filed: Jan. 18, 2006

Related U.S. Application Data
(60) Provisional application No. 60/645,621, filed on Jan. 21, 2005.

(51) Int. Cl. B23K 26/00

(52) U.S. Cl. 219/121.85; 219/121.77

(57) ABSTRACT

A high-speed, precise, laser-based material processing method and system are provided wherein relative movement of target material and a pulsed laser output used to process the material are synchronized. The laser-based system includes a pulsed laser source for generating a set of laser pulses, and a laser output control that controllably selects a subset of pulses from the set of laser pulses at a position beyond the laser source to obtain the pulsed laser output. The laser-based system further includes a mechanism for synchronizing the pulsed laser output with relative movement of the target material. A beam delivery and focusing subsystem delivers at least a portion of the synchronized pulsed laser output to the target material as a laser material processing output to process the target material. A positioning subsystem moves the target material relative to the pulsed laser output.

### CROSS-REFERENCE TO RELATED PATENTS AND APPLICATIONS

This application claims the benefit of U.S. provisional application Ser. No. 60/645,621, filed Jan. 21, 2005. This application hereby incorporates the following U.S. patents and patent applications in their entirety herein: U.S. Pat. Nos. 6,791,059; 6,744,288; 6,727,458; 6,573,473; 6,381,259; 2002/0167581; 2004/0134896, and U.S. Ser. No. 11/317,047, filed Dec. 23, 2005, entitled “Laser-Based Material Processing Methods, Systems and Subsystem for Use Therein for Precision Energy Control. ” These patents and publications are assigned to the Assignee of the present invention.

### BACKGROUND OF THE INVENTION

1. Field of the Invention

The invention generally relates to precision, high-speed, laser-based processing of target material. Another application is laser-based micro-machining. One such application is laser-based repair of a redundant semiconductor memory.

2. Background Art

Integrated circuit memory repair systems use a laser to open links on integrated circuit memory die in order to select only properly functioning memory cells. When manufactured, memory die typically have some number of defective memory cells. To make memory die with defective memory cells usable, memory die are typically manufactured containing extra memory cells that can be used in place of defective cells. The memory cells on a memory die are typically arranged in a matrix of rows and columns of memory cells. Extra memory cells are included on the memory die by increasing the number of rows and columns of the memory matrix by including excess rows and columns of memory cells. Defective memory cells in the memory matrix are avoided (not used) by modifying memory matrix addressing to select only defect free matrix rows and columns. Links are used to modify memory matrix addressing. A laser is used to open (blast) the desired links. The system, used for modifying memory addressing, containing the laser is a “memory repair system.”

Memory die are processed to select only defect free memory cells before the wafer is diced. Typically memory wafers are 200 mm or 300 mm in diameter.

The links on memory die are typically arranged in groups of links where each group consists of a row or column of links. Within each row or column the links are spaced at equal increments, the links look like the rungs on a ladder. Link size and spacing vary significantly dependent on the manufacturer and the memory design. Link dimensions for a typical memory design may be 0.4 μm wide, 4 μm long with 3 μm space between links.

The memory repair system is given a map of link locations on the memory die and a file listing which links on each die on the wafer should be opened (blasted). Not all links on a die are blasted and the links blasted on each die are typically different. The memory repair system opens the links using a laser. A laser beam is focused onto the link to be opened and the laser is pulsed. A single laser pulse is used to open a link.

The wafer is held on a precision XY stage when laser pulses blast links on the wafer. The XY stage positions the links to be blasted at the XY (horizontal plane) location of the focused laser beam. Laser focus is maintained on the plane of the wafer during link blasting by adjusting laser focus position in the Z (vertical axis); the focused laser beam is moved only in the vertical (Z) direction during link blasting.

Each link is blasted with at single laser pulse. When blasting a group of links the laser is fired (pulsed) at approximately a constant repetition rate. Firing the laser at a constant repetition rate helps maintain a precise and constant amount of energy in each laser pulse thereby providing consistent laser energies to each link blasted.

Typically, all links in a link group are equally spaced and the laser is pulsed at a substantially constant repetition rate while blasting links. Therefore, the stage is moved at a constant velocity during link blasting in order to position each successive link of a link group at the location of the focused laser beam at the time of the next laser pulse. For example, if the laser repetition rate is 50 KHz and links are spaced 3 μm apart, then the maximum stage velocity used is (3 μm) (50 KHz)=150 mm/s. A slower velocity could also be used where the slower velocity equals the maximum stage velocity divided by an integer. Therefore, for the above example, velocities of 75 mm/s, 50 mm/s 37.5 mm/s etc. could also be used. The constant velocity move used during link blasting is referred to as a CV move.

During link blasting, small timing corrections (phase corrections) are made in laser firing time to correct for small stage positioning errors.

During blasting, the laser is fired at a substantially constant repetition rate such that each laser pulse corresponds to a single link in a group of links. Not all links in a group are typically blasted, therefore not all fired laser pulses are used to blast links. A pulse selector, typically an acoustic optic modulator (AOM), is used to route fired pulses either through the focusing lens to the link if the link is to be blasted or to a beam dump if the link is not to be blasted. The acoustic optic modulator is typically also used to reduce the laser pulse energy to the desired energy for blasting a link.

After blasting a group of links at a constant velocity the stage is moved to the next link group to be blasted. The stage move trajectory for moves between link groups is computed to position the stage at the beginning of the next group with the appropriate velocity for blasting the next group. These non-constant velocity moves between link groups are referred to as PVT (position velocity time) moves. The end point requirements for the move are a position, a velocity, at a specified time. The specified time is required in order to coordinate the stage X direction move with the stage Y direction move so that at the end of the move both axis meet the end point requirements at the same time.

Note, as explained above, there are two basic types of stage moves: 1) constant velocity moves, CV moves; and 2) non-constant velocity moves, PVT moves.

As shown in FIG. 2a, a system controller coordinates all activities during processing. These activities include laser firing, stage/substrate motion, and pulse selection. Typically stage motions are commanded to provide constant velocity (CV) move segments such that the links to be blasted are positioned at the location of the focused laser beam and then laser firing is synchronized to the stage motion. Laser firing is controlled by a laser trigger signal sent from the system controller to the laser. When the laser receives a trigger signal, a laser pulse is generated. The laser pulse generated occurs some small delay time after the trigger signal active edge. The delay time varies slightly for each pulse resulting in a small jitter in the laser firing time. Typically, the laser generates a pulse at the time of the trigger signal by either changing the state of a Q switch or by pulsing a seed laser. The laser repetition rate typically used for memory repair is less than 100 KHz, typically in the 30 KHz to 60 KHz range.

In previous systems, laser pulses used for blasting links in memory repair systems are generated to be synchronous to the motions of the substrate. A trigger signal originating in the memory system controller and terminating at the laser is used by the laser to signal the time to either change the state of a Q switch or to pulse a seed laser to generate a laser pulse; laser pulses are generated (physically produced) on demand. Typical laser repetition rates used for memory repair are in the 30 KHz to 100 KHz range.

The capacity of redundant semiconductor memory devices is increasing, and corresponding link dimensions and pitch (center to center spacing of links) are generally shrinking. It is desirable to increase the throughput of laser-based memory repair systems, the number of links processed each second. By way of example, a motion stage may transport a substrate supporting thousands of target links at a speed of about 150 mm/sec. Each target link to be removed may have a width of about 0.4 microns or finer. An adjacent non-target link, not to be processed, may be about 2 microns or less from a target link. One or more pulses are to be used to process only each target link “on the fly,” and the corresponding focused laser output is to impinge each target link within a region centered on the link, the region having a dimension only slightly larger than a diffraction limited output corresponding to a single output pulse. For example, in FIG. 1, the dimension of the focused laser processing output caused by displacement of the two pulses is increased by about one-quarter or one-tenth a link width. In any case, the focused laser processing output (one or more pulses) must remove only the target links and avoid undesirable damage to at least the substrate and non-target links.

Many pulsed laser sources used for link blowing may be triggered by a control signal when a processing pulse is needed (see FIG. 2a). Exemplary sources include actively q-switched diode pumped laser sources, or a MOPA (Master Oscillator-Power Amplifier) having a seed laser diode. Over the past several years, the assignee of the present invention and others utilized either an active q-switched system or a MOPA diode-based configuration in various commercially-available link blowing systems.

Certain pulsed laser sources, for instance mode-locked lasers or passively q-switched micro-lasers, are difficult or impractical to directly control with a trigger or synchronization signal. Various pulse characteristics of such lasers are useful for link blowing and other micromachining applications. It is desirable to utilize the output of such a source without being limited by an excessive tradeoff between precision and throughput.

Consequently, there is a need for a laser processing method and system that more effectively utilizes the source output as a result of improved synchronization between the pulsed laser source and other system components. As such, such a method and system should provide for increased micromachining precision and faster processing speeds.

### SUMMARY OF THE INVENTION

An object of the invention is to provide an improved method and system for high-speed, laser-based, precision material processing to at least partially satisfy some of the above-noted needs and solve at least some of the above-noted problems.

In carrying out the above object and other objects of the present invention, a laser-based material processing method includes providing a pulsed laser source for generating a set of laser pulses, and controllably selecting a subset of pulses from the set of laser pulses at a position beyond the laser source to obtain a pulsed laser output. The laser-based material processing method further includes synchronizing the pulsed laser output with relative movement of target material, and selectively delivering at least a portion of the synchronized pulsed laser output to the target material as a laser material processing output to process the target material.

The step of controllably selecting may include the step of receiving a control signal.

The step of synchronizing may include the step of setting phase of the pulsed laser output in response to at least the control signal to synchronize the relative movement of the target material with the pulsed laser output that is used to process the target material.

The step of controllably selecting may include the step of receiving a time-based input related to a pulse of the set.

The step of setting may include the step of producing, in response to both the control signal and the time-based input, a pulse selection signal to at least initiate selection of the subset of pulses.

Temporal position of the pulse in the set may be independent of the relative movement.

The set of laser pulses may be a high repetition rate laser pulse train. During the step of controllably selecting, pulses may be selected from the high repetition rate laser pulse train to produce laser output pulses having a reduced repetition rate and a desired phase.

The step of selectively delivering may include the step of selecting a portion of the laser output pulses to produce the processing output.

The step of setting may produce a subset of substantially periodic pulses that are phase-shifted relative to at least some output pulses that precede the control signal.

The step of setting may introduce a constant delay between phase-shifted pulses, to within an approximate phase jitter.

The step of setting may further include the step of substantially minimizing a delay between a pulse that immediately precedes the control signal and a first phase-shifted pulse of a subset of output pulses that immediately follows the control signal.

The target material may be a target structure, and the processing may include removing the structure with a group of pulses of the processing output.

The step of setting may cause the processing output to impinge a region which is centered within 10% of a center of the target structure during motion of the pulsed laser output relative to the target structure, whereby an improvement in at least one of laser processing throughput and precision results relative to a non-phase shifted laser material processing output.

The method may further include amplifying a portion of the set of laser pulses to produce a series of amplified laser output pulses.

The method may further include selecting at least a portion of the amplified laser output pulses to produce laser material processing pulses and directing the selected laser material processing pulses to the target material.

Further in carrying out the above object and other objects of the present invention, a laser-based material processing system includes a pulsed laser source for generating a set of laser pulses, and a laser output control that controllably selects a subset of pulses from the set of laser pulses at a position beyond the laser source to obtain a pulsed laser output. The laser-based material processing system further includes a mechanism for synchronizing the pulsed laser output with relative movement of target material. A beam delivery and focusing subsystem delivers at least a portion of the synchronized pulsed laser output to the target material as a laser material processing output to process the target material. A positioning subsystem moves the target material relative to the pulsed laser output.

The system may be a high-speed, laser-based micromachining system for modifying the target material.

The target material may be a target structure, and the processing may include at least partially removing the structure.

The laser output control may set a phase of the pulsed laser output in response to at least a control signal.

The laser output control may receive the control signal and a time-based input related to a pulse of the set and, in response to the control signal and the time-based input, may at least initiate selection of the subset of the set.

The system may further include a detector which detects pulses generated by the laser source to obtain the time-based input.

The system may further include an optical amplifier for amplifying pulses selected by the laser output control, and an output modulator for selectively directing amplified pulses to the beam delivery and focusing subsystem.

The system may further include a wavelength shifter that receives the amplified pulses, the amplified pulses having a first wavelength, and shifts the first wavelength to a shorter wavelength.

The first wavelength may be about 1.064 microns and the shorter wavelength may be about 0.532 microns.

The laser source may generate a substantially periodic pulse train having a MHz repetition rate, and the control may select a subset of the pulse train to obtain a reduced repetition rate.

The reduced repetition rate may be substantially less than the repetition rate of the pulse train.

The reduced repetition rate may be in a typical range of 20 KHz up to a predetermined rate that is sufficiently high to avoid substantially limiting throughput of the material processing system.

The reduced repetition rate may be in a typical range of about 20 KHz to 500 KHz.

The control may select groups of pulses of up to about 200 pulses per group, each group being selected so that groups of output pulses occur at a repetition rate substantially less than the repetition rate of the pulse train.

Spacing between pulses within a group may correspond to the repetition rate of the pulse train.

The system may further include an optical amplifier to amplify each selected group of pulses.

The system may further include an output modulator to selectively direct at least one group of amplified pulses to the beam delivery and focusing subsystem.

The pulsed laser source may be a mode-locked solid state laser.

The pulsed laser source may be a mode-locked laser that generates pulses at a repetition rate of about 10 MHz-200 MHz.

Movement of the target material relative to a laser material processing output may be about 8 mm/s to about 200 mm/s.

The control may include an electro-optic or acousto-optic device.

The output modulator may select a portion of the amplified pulses to be directed to the beam delivery and focusing subsystem.

One aspect of the invention features a method of laser processing a target material. The method includes synchronizing relative movement of the target material and a pulsed laser output that is used to process the target material.

Another aspect of the invention features a laser processing system for processing target material.

Another aspect of the invention features a method of laser-processing target material. The method includes receiving a trigger or control signal; setting the phase of laser output pulses based on the trigger signal to synchronize relative movement of a target structure with a pulsed laser output that is used to process the target material; and selectively delivering at least one output pulse to the target material to process the target material.

Another aspect of the invention features a laser processing system that includes a sub-system for synchronizing relative movement of target material and a pulsed laser output that is used to process the target material.

These and other features, aspects, and advantages of the invention will become better understood with regard to the following description, appended claims, and accompanying drawings.

### BRIEF DESCRIPTION OF THE DRAWINGS

FIG. 1 shows an exemplary pulsed laser output for removing a target structure, for instance a link of a redundant semiconductor memory;

FIGS. 2a and 2b are a schematic block diagram and associated timing diagrams, respectively, showing some elements for controlling laser output in a prior laser material processing system;

FIGS. 3a and 3b are a schematic block diagram and associated timing diagrams, respectively, showing some elements for controlling laser output in an embodiment of the present invention;

FIGS. 4a and 4b are a schematic block diagram and associated timing diagrams, respectively, showing several elements of a laser processing system corresponding to at least one embodiment of the present invention;

FIGS. 5a-5c show timing diagrams that exemplifies pulse generation and control of the pulsed laser system of FIG. 4a;

FIG. 6a is a schematic block diagram showing several elements of a laser processing system corresponding to another embodiment of the present invention; and

FIG. 6b shows timing diagrams that exemplifies pulse generation and control of the pulsed laser system of FIG. 6a.

### DETAILED DESCRIPTION OF THE PREFERRED EMBODIMENTS

Laser-Based Memory Repair Methods/Systems

The following representative patents and published applications generally relate to methods and systems for laser-based micro-machining, and, more specifically, memory repair. These patents and publications are assigned to the assignee of the present invention and are incorporated by reference in their entirety herein.

U.S. Pat. No. 6,791,059, entitled “Laser Processing” (hereafter the '059 patent).

U.S. Pat. No. 6,744,288, entitled “High-Speed Precision Positioning Apparatus” (hereafter the '288 patent).

U.S. Pat. No. 6,727,458, entitled “Energy-Efficient, Laser-Based Method And System For Processing Target Material” (hereafter the '458 patent).

U.S. Pat. No. 6,573,473 entitled “Method And System For Precisely Positioning A Waist Of A Material-Processing Laser Beam To Process Microstructures Within A Laser-Processing Site” (hereafter the '473 patent).

U.S. Pat. No. 6,381,259 entitled “Controlling Laser Polarization” (hereafter the '259 patent).

Published U.S. Patent Application 2002/0167581, entitled “Methods And Systems For Thermal-Based Laser Processing A Multi-Material Device” (hereafter the '581 application).

Published U.S. Patent Application 2004/0134896, entitled “Laser-Based Method And System For Memory Link Processing With Picosecond Lasers” (hereafter the '896 application).

U.S. Pat. No. 6,559,412 entitled “Laser Processing” (hereafter the '412 patent).

At least the following cited portions of the above patent documents are particularly pertinent to understand the various features, aspects, and advantages of the present invention:

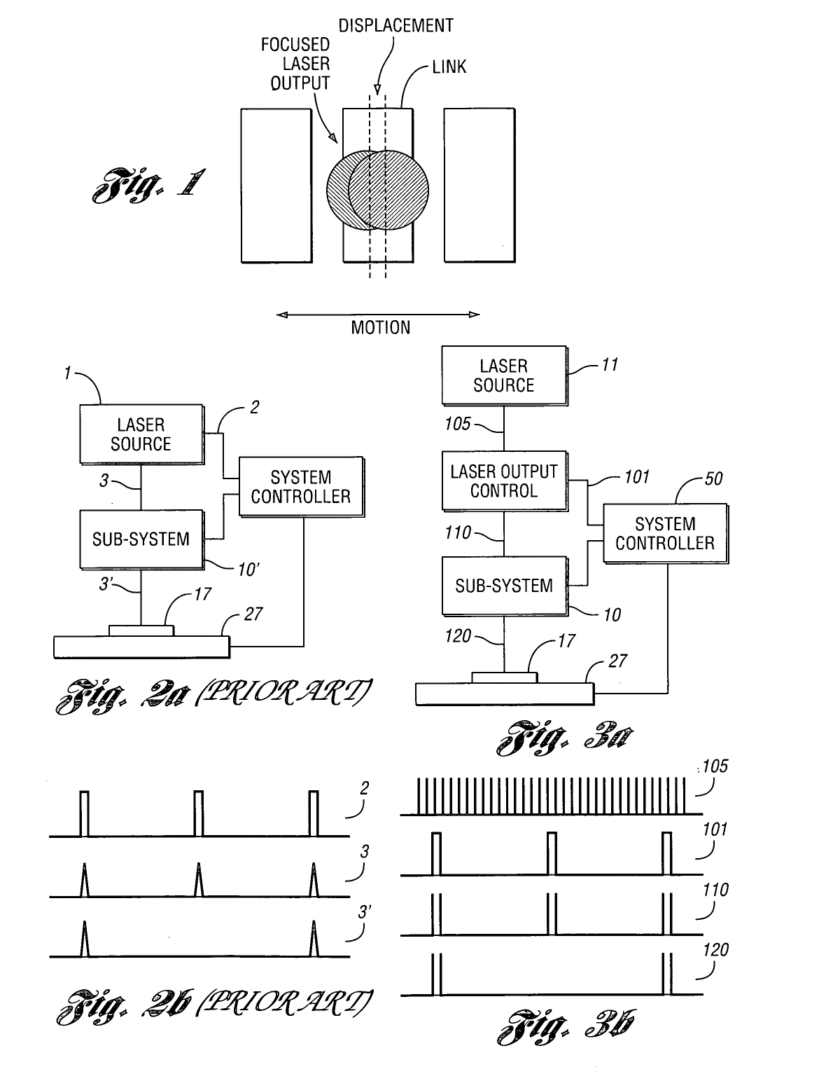

FIG. 9 of the '896 application shows a block diagram of a laser-based memory repair system having a picosecond laser. FIGS. 1a -1b, 2a-2b, 7, and 8a-8e and the corresponding text generally relate to pulse generation, pulse picking and amplification. FIG. 1c shows a focused laser processing output (i.e. two pulses) that impinges a target structure during motion of the laser output relative to the structure.

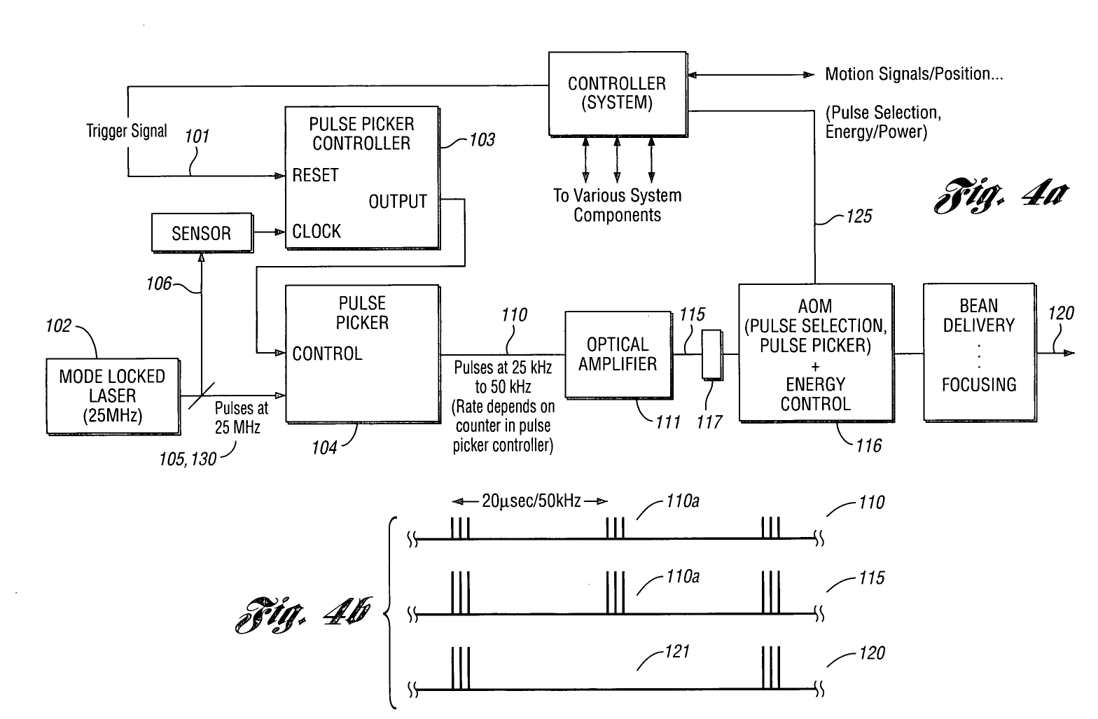

Exemplary embodiments related to high speed motion control and positioning, including beam waist positioning in three dimensions, are found in the drawings and text of at least the '288 and '473 patents. Both the '288 and '473 patents generally describe exemplary motion segments used in link blowing systems provided by the assignee of the present invention. Precision X,Y,Z positioning systems suitable for link processing and other laser-based micromachining applications are described in the '288 and '473 patents. For example, FIGS. 3, 8 and 9 and the corresponding text of the '473 patent disclose a beam delivery and focusing system used in various link blowing systems produced by the assignee of the present invention.

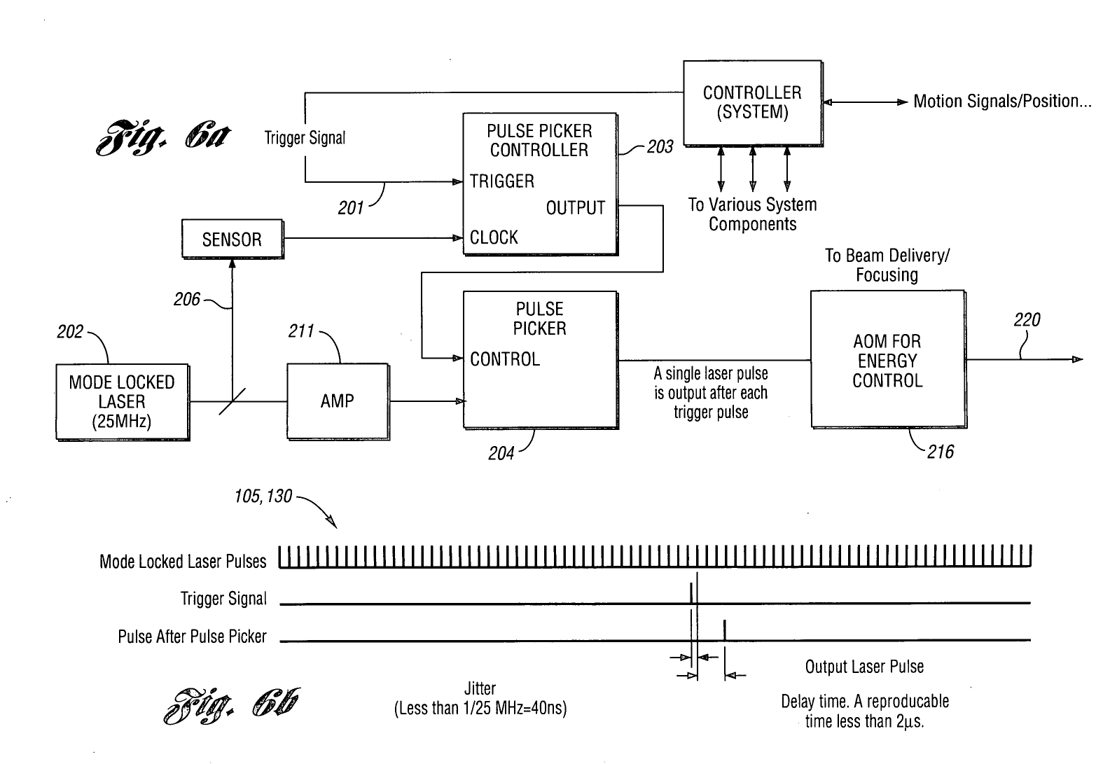

The '059 patent generally relates to laser processing of links. FIG. 5 and the associated text describe a system that includes an acousto-optic modulator for pulse selection and energy control.

Additional related information can be found at least in the '059 patent, the '458 patent, the '581 published application, and the '896 published application.

Overview

The present disclosure makes reference to “picking” or “selection” of a single pulse, a group of pulses or, more generally, to “picking” or “selection” of consecutive or non-consecutive pulses from a series or set of pulses. Unless stated otherwise, “picking” and “selection” are to be regarded non-limiting and synonymous. For example, in the following description and accompanying drawings “pulse picking” or “pulse selection” may be carried out with an optical switch placed before an amplifier, or with optical switches both before and after an amplifier. In certain embodiments, a single optical switch may be used for picking/selection after an amplifier, provided certain conditions disclosed herein for proper operation are satisfied.

The present disclosure also refers to “synchronizing relative movement” and corresponding “control,” “synchronization” or “trigger” signals. Unless otherwise stated, the relative movement may be associated with, and corresponding signals derived from, at least one of acceleration, velocity, and position information.

The present disclosure also makes reference to a “burst” of pulses. The term is intended to be descriptive rather than limiting, and with reference to a relative rather than absolute time scale. As will become apparent from the disclosure, a burst is generally regarded as a group of closely spaced, short pulses that appear in rapid succession if displayed at a certain time scale. The width of a pulse within the group, the temporal spacing between two pulses within the group, or the duration of the group are generally substantially less than a time period corresponding to an inactive period.

Unless otherwise stated, the terms “repetition rate” and “repetition frequency” are to be regarded as synonymous, and refer to the number of single pulses, or groups of pulses, occurring within a time interval.

”Target material” is intended to be descriptive rather than limiting, and generally refers to a material (or combination of materials) that is to be impinged or intentionally affected with a laser processing beam. The target material may be a portion of a substrate, a workpiece, a structure supported by and transported with the substrate, a portion of a semiconductor device, and the like.

One aspect of the invention features a method of laser processing a target material. The method includes synchronizing relative movement of the target material with a pulsed laser output that is used to process the target material.

At least one embodiment of the invention includes a method of laser-processing a target material. The method includes: generating a series or set of laser pulses; providing a control signal; selecting at least one pulse or subset of pulses from the set to produce a pulsed laser output based on the control signal; and selectively delivering at least a portion of the pulsed laser output to the target material as a laser material processing output to process the target material.

Another aspect of the invention includes providing a laser processing system that, when operated, carries out the above method.

The method may also include setting the phase of a laser processing output based on at least the control signal to synchronize relative movement of a target material and a pulsed laser output that is used to process the target material.

Setting the phase may include accepting the control signal and a time-based input related to a pulse in the first series; and producing, in response to both the signal and input, a pulse selection signal to at least initiate selection of at least one pulse of the first series.

The temporal position of a pulse in the first series of pulses may be independent of the relative movement.

In at least one embodiment the series may be a high repetition rate laser pulse train, and the method may include selecting pulses from the high repetition rate laser pulse train to produce laser output pulses having a reduced repetition rate, and having desired phase.

In at least one embodiment the step of selectively delivering includes the step of selecting a portion of the laser output pulses to produce a laser material processing output.

Setting the phase of laser output pulses based on the trigger signal may produce a series of substantially periodic pulses that are phase shifted relative to at least some output pulses that precede the trigger signal.

Setting the phase may introduce a constant delay between phase shifted pulses, to within an approximate phase jitter.

Setting the phase may include substantially minimizing a delay between a pulse that immediately precedes the trigger signal and a first phase-shifted pulse of a series of output pulses that immediately follows the trigger signal.

In at least one embodiment of the invention, the target material may be a target structure and processing may include removing the structure with a group of pulses as a laser-processing output. Setting the phase may cause the laser-processing output to impinge a region which is centered within 10% of the center of the target structure during motion of the laser output relative to the target structure, whereby an improvement in at least one of laser processing throughput and precision results relative to a non-phase shifted laser material processing output.

At least one embodiment of the present invention method may include amplifying at least a portion of output pulses to produce a series of amplified laser output pulses.

An embodiment may also include selecting at least a portion of the amplified pulses to produce laser material processing pulses; and directing the selected processing pulses to the target material.

One aspect of the invention includes a high-speed, laser-based micro-machining system for modifying target material.

Another aspect of the invention features a laser processing system for processing a target structure.

Another aspect of the invention features a system for laser processing a target material. The system includes a mechanism for synchronizing relative movement of the target material with a pulsed laser output that is used to process the target material.

Another aspect of the invention features a laser processing system that is used to process the target material. The system includes at least one controller that coordinates relative movement of the target material with a pulsed laser output.

In at least one embodiment a controller sets the phase of a series of laser output pulses based on the trigger signal.

At least one system of the present invention may include: a pulsed laser source; at least one modulator that selects pulses from the laser source, a controller operatively coupled to a modulator for synchronizing relative movement of target material and a pulsed laser output based on a trigger signal; a beam delivery and focusing system for directing the pulsed laser output to the target material; and a positioning sub-system for positioning the target material relative to the pulsed laser output.

In at least one embodiment, a controller is a laser output controller that accepts a trigger signal and a time-based input related to a pulse of the laser source and, in response to the signal and input, at least initiates selection of at least one pulse emitted from the source.

The time-based input may be a signal obtained at output of a detector that detects pulses emitted by the source.

The system may further include an optical amplifier for amplifying pulses selected by the modulator, and an output modulator for selectively directing amplified pulses to a beam delivery and focusing system.

The system may further include a wavelength shifter, for instance a frequency doubler, that accepts the amplified pulses, the amplified pulses having a first wavelength, and shifts the wavelength to a frequency doubled shorter wavelength.

The first wavelength may be about 1.064 microns and the shorter wavelength about 0.532 microns.

The pulsed laser source may emit a series of pulses, for instance a substantially periodic pulse train having a MHz rate, and the at least one modulator may select at least one pulse of the pulse train so that output pulses occur at a reduced repetition rate.

The reduced repetition rate may be substantially less than the rate of the pulse train.

The reduced rate may be in a typical range of 20 KHz up to a predetermined rate that is sufficiently high to avoid substantially limiting the throughput of the material processing system.

The reduced rate may be in a typical range of about 20 KHz to 200 KHz.

The at least one selected pulse may be a group of up to about 20 pulses, each group being selected so that groups of output pulses occur a rate substantially less than the rate of the pulse train.

The spacing between pulses within the group may correspond to the rate of the pulse train.

An optical amplifier may amplify each group of selected pulses.

An output modulator may be included to selectively direct at least one group of amplified pulses to a beam delivery and focusing system.

The pulsed laser source may be a mode-locked solid state laser.

The laser source may be a mode-locked laser that emits pulses at a rate of about 20 MHz-100 MHz.

The motion of the target material relative to a laser processing output may be about 8 mm/s to about 200 mm/s.

The modulator may be an electro-optic or acousto-optic device.

An output modulator may select a portion of the amplified pulses.

In various embodiments of the present invention, and in contrast to previous methods, laser pulses emitted at the output of a laser source are not directly generated in response to a control signal. FIG. 2a is a simplified schematic that shows some elements for laser control in a prior laser processing system. In laser processing application, for instance link blowing, a control signal 2 may synchronize motion of target material 17 with the output 3 of externally triggered laser source 1. By way of example, a typical laser source 1 may be an active q-switched laser or seed diode, both which may be triggered with the external signal 2. The control signal 2 may be a timing signal representative of a target position.

FIG. 3a is a simplified schematic diagram that shows some elements for laser control in a system corresponding to one embodiment of the present invention. In at least one embodiment of the invention a free running laser source 11 provides laser pulses 105 for removing links in memory repair systems. The laser 11 continuously generates pulses 105 at a constant repetition rate, and with fixed phase. For example, a mode locked laser 11 generates pulses at a fixed pulse repetition rate with a fixed phase. Typically the pulse repetition rate is greater than 20 MHz, typically at least a factor of ten greater than a present link processing requirements.

As will become apparent from the present disclosure, a laser system of the present invention may include a mode locked laser followed by an optical amplifier.

Furthermore, suitable combinations of optical, electronic, and electro-optic components are provided in a subsystem 10 to satisfy specific laser material processing application requirements. Some elements may be operated by a system controller 50, under computer control. The components may include, but are not necessarily identical to, elements of subsystem 10′ of FIG. 2a.

Synchronization of laser pulses to the motion of the target material, or a substrate or other surface that supports the material, is accomplished by selecting pulses from the free-running, mode locked laser pulse train (i.e., 105 in FIG. 3b). However, pulses are still required by the memory repair system at a typical repetition rate in the 30 KHz to 100 KHz range, presently not at MHz rates. It is noted that in FIG. 1, the target material is typically in motion. However, embodiments of the present invention may include any suitable combination of relative motion of the laser output and the target material.

Selecting pulses from a free running pulse train 105 results in increased uncertainty in the actual time that the pulse will be delivered to the target material, effectively increased pulse time jitter. This increase in pulse time jitter translates into a small increase in positional error when removing a link if the stage 27 is moving at a constant velocity during processing. The corresponding increased pulse time jitter is approximately equal to the time between laser pulses of the free-running laser 11. For example, if a substrate supporting the target material 17 and a supporting positioning stage 27 are moving at 150 mm/s and the laser free running repetition rate is 50 MHz, then the time between laser pulses is 1/(50 MHz)=20 ns. The substrate/stage motion during 20 ns when moving at 150 mm/s is (20 ns)*(150 mm/s)=3 nm. If a link is 0.4 μm wide then 3 nm corresponds to ((3 nm)/(0.4 μm))*(100)=0.75% of the width of the link, an acceptable motion during linkprocessing.

Reference is made to the '473 and '288 patents for further description of motion segments and profiles, including constant velocity segments commonly used during laser processing of links, herein sometimes referred to as link “blasting. ” For example, FIGS. 10a-10b of the '473 patent and the corresponding text in columns 13-14 thereof relate to profiles and relative motion.

The small increase in blast position error caused by the increase in pulse time uncertainty (increased jitter) can be effectively eliminated by synchronizing the stage/substrate motions to the laser repetition rate. This is achieved by adding an additional constraint on stage move profile generation. This additional constraint requires that the first blast position of a blast segment occurs at such a time that the appropriate time/phase relationship exists with the laser to result in minimal laser pulse time uncertainty. Using this method of synchronization allows for synchronizing a free-running laser or laser amplifier system of any repetition rate to the motions of the substrate/stage with minimal pulse time uncertainty and therefore minimal position uncertainty.

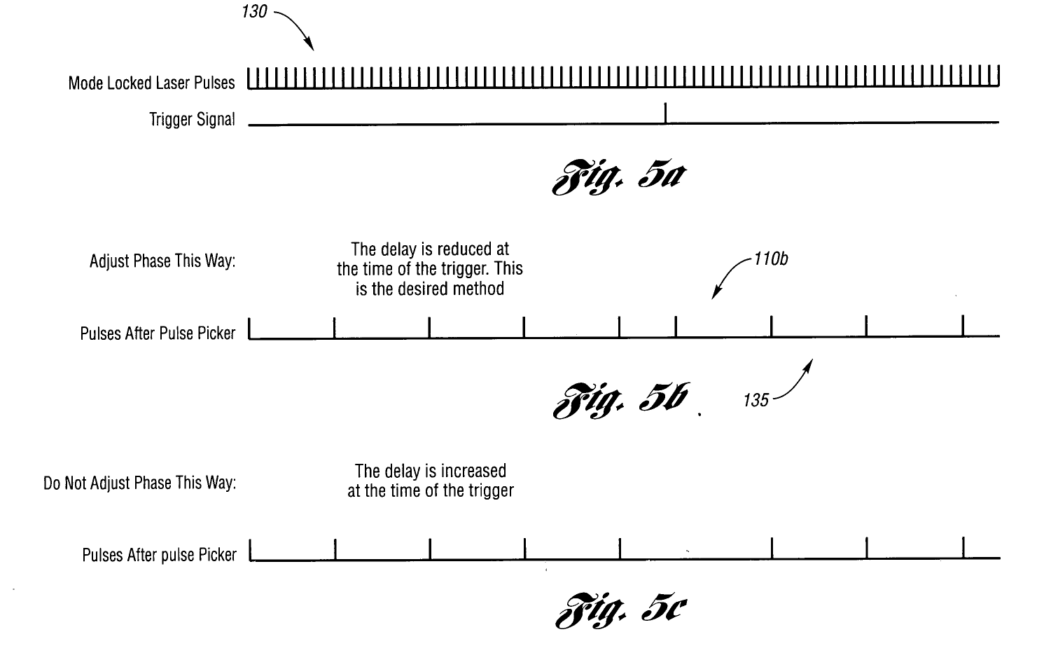

FIG. 4a shows elements of a laser system constructed in accordance with an embodiment of the invention in further detail. In the case where the laser system also includes one or more amplifiers 111, pulses may be selected either before or after the optical amplifier 111. Selecting pulses before the optical amplifier 111 may be beneficial. Selecting pulses before the optical amplifier 111, referred to as “down counting” in the '896 application, may reduce the average power after the amplifier 111 thereby resulting in a smaller amplifier.

When pulses are selected before the optical amplifier 111 there may be additional special requirements on pulse selection in order to maintain optimal operation of the amplifier 111 and to generate pulses with desired pulse energies. When selecting pulses before the optical amplifier 111, it may be desirable to select pulses at a constant repetition rate and modify the phase of the selected pulses to synchronize the pulses to the motion of the substrate/stage. Selecting pulses at a constant repetition rate before the optical amplifier 111 prevents the optical amplifier 111 from storing energy and then producing unacceptably high-energy pulses for the first pulses of a new pulse train. If pulses are selected at a constant repetition rate and the phase of the selected pulses is modified to synchronize the pulses to the motion of the substrate/stage then an additional laser pulse selector, typically an acoustic optic modulator (AOM) 116 or other suitable optical switch, may be required. The switch 116 is placed after the optical amplifier 111 to select pulses of the continuous, reduced repetition rate output pulse train 115 exiting the optical amplifier 111. This second or output pulse selector 116 is typically also used to reduce the laser processing output pulse energy, the energy that is to impinge the link, to a desired value for blasting a link, or for other material processing operations.

In embodiments where pulse selection is done after an optical amplifier or where an optical amplifier is not used, then the laser pulse selector 104 can be the only pulse selector required in the system. A second pulse selector, typically an acoustic optic modulator (AOM) 116, is not required. However, the acoustic optic modulator (AOM) 116 may be of general use to reduce or otherwise regulate the pulse energy to the desired value for blasting a link, and the arrangement may still be required, or at least desirable, for obtaining improved precision.

In various embodiments, a “burst,” exemplified by closely spaced pulses 110a (i.e., FIG. 4b), may be used to blast a single link. The pulses in the burst 110a are separated by a time interval corresponding to the repetition rate of the free-running laser (typically>20 MHz). Since the pulses in a single burst 110a are closely spaced in time, the substrate/stage 27 can still be moving at a constant velocity when blasting the links, the distance of substrate/stage movement during the length of time for the complete burst of pulses is small compared to the dimensions of the link. For example, if the substrate/stage 27 is moving at 150 mm/s, the laser free-running repetition rate is 50 MHz, and a burst of 10 pulses is used from the laser to blast a single link, then the time for the complete burst of pulses is (10)/(50 MHz)=200 ns. The substrate/stage motion during 200 ns when moving at 150 mm/s is (200 ns)*(150 mm/s)=30 nm. If a link is 0.4 μm wide then 30 nm corresponds to ((30 nm)/(0.4 μm))*(100)=7.5% of the width of the link, an acceptable motion during link blasting.

“Pulse Picking”—Laser Pulse Train with Amplification

Referring to FIG. 4a, in at least one embodiment of the present invention, a mode locked laser 102 is used to produce a series of pulses, for instance pulse train 105, at a relatively high repetition rate, for instance 25 MHz, 50 MHz, or higher. A control signal, for instance trigger signal 101, is provided to synchronize the laser processing system components (not shown in FIG. 4a, but shown in the '059 patent) and a pulsed laser output 120 for processing that exits the beam delivery system and impinges target material (not shown). The system components may include X,Y motion stages that transport a wafer that supports links or other target structures, and a corresponding Z-axis mechanism for lens movement (dynamic focus). Control module or controller 103, an element of a subsystem or laser output control, receives the trigger signal 101. A pulse from the laser 102 is detected with an exemplary arrangement 106 including a beam splitter and high-speed photodetector or sensor—these events produce a change in the output state of the pulse picker controller 103, and subsequent gating of a predetermined number of pulses by a pulse picker 104. The pulse picker 104 includes a suitable optical switch, typically a Pockels cell with nanosecond or faster rise time. The pulse picker 104 receives an output signal from the control module 103 that “gates” a single pulse 110b (as shown in FIG. 5b) or group of pulses 110a (for instance 3 pulses as shown in FIG. 4b) which then become available at the output of pulse picker 104. The output pulses 110 may be amplified with optional optical amplifier 111, for instance an optical fiber or other solid state laser amplifier. The nearly constant repetition rate of pulses 110 at the amplifier input also provides for stable operation of the amplifier 111. A separate acousto-optic modulator 116 (or other suitable optical switch) may then be used to select each amplified pulse or group of amplified pulses 115 as a pulsed laser material processing output for delivery to the target material. The AOM 116 may be further used to control the energy of laser processing pulses 120, or optionally for alignment, as disclosed in the '059 patent.

An optical switch will generally require “pre-optics” and “post-optics” (not shown) that transform collimated input beams to specified focused beams, with the reverse operation on the switch output. These well known elements are generally used throughout the industry.

Selected pulses for processing are transmitted to a beam delivery and focusing subsystem as a pulsed laser output for processing at least one target link (or other target material). The beam delivery and focusing (optical) system (details not shown in FIG. 4a, refer to at least to the '896 application and the '473 patent) generally includes focusing optics, beam steering components, polarization switches, optical isolators, and the like, as needed, for producing a suitable material processing beam.

By way of example, a group, sometimes referred to as “burst,” of 3 pulses 110a are shown in FIG. 4b at an output repetition rate of 50 KHz. In this example, 2 of these 3 groups are used for processing two target links, the non-selected group 121, associated with a link not to be processed, is directed to a beam dump (not shown). The pulses of each selected burst may then be used to remove a target link.

The output pulses 110a in this example have a temporal spacing corresponding to consecutive pulses of pulse train 105 (50 KHz= 1/20 usec). For instance, a spacing of 40 ns corresponds to a 25 MHz rate. The number of pulses in a group 110a is generally dependent upon at least the spot size and energy per pulse, as well as other material properties. Increasing the delay between pulses can be of benefit in some material processing applications. Accordingly, the pulse picker 104 may then be operated to select non-consecutive pulses. Similarly, a suitable modulator 116 may be operated to select non-consecutive pulses.

Further, the example associates a single group 110a with a single link; the three groups corresponding to three consecutive links in a row. In certain material processing applications, for instance microstructuring or drilling, the groups may generally be associated with target material. By way of example, the three groups, or other predetermined number of groups, may be used to process target material or a region thereof.

In at least one embodiment of the present invention, servo tracking errors associated with the motion control system are compensated by setting the phase of a sequence of pulses 110 or 115 based on at least the trigger signal 101. The phase of subsequent pulses at the output of the pulse picker 104 is effectively shifted and thereby synchronized with the trigger signal 101. The phase adjustment provides capability for accepting a trigger signal for each pulse (or group of pulses) used to process a target link.

The following paragraphs further illustrate preferred, non-limiting, principles of operation of the pulsed laser material processing system of FIG. 4a. The exemplary operation is particularly suited for memory repair, but may be adapted for use in other precision, laser-based, micro-machining operations: for instance marking, trimming, micro-drilling, micro-structuring, patterning, flat panel display or thin film circuit repair, and similar high-speed applications that require precision timing and precise placement of laser processing pulses on target material.

Phase Jitter Compensation, Synchronization, and Triggering

By way of example, an average repetition rate of output pulses, whether a single pulse 110b (i.e., FIG. 5b) or a group 10a (FIG. 4b), may be from 10 KHz to 30 KHz, 20 KHz to 50 KHz, preferably up to about 200 KHz. In any case, it is desirable to provide material processing pulses at a rate fast enough such that the throughput and precision of laser processing system is limited by other components.

The process of producing the output at a decreased repetition rate is sometimes also referred to as “down counting” in the '896 application. FIG. 4b shows a 50 KHz output rate (20 usec) with groups of three pulses, each group being regarded as a burst on the time scale shown, each pulse within the burst spaced by about 40 nanoseconds. Various modifications of the output rate and pulse spacing may be made based on teachings in the '458 patent, the '581 application, and the '896 application. Various modifications of selection of the laser source 110 or optical switch may be used to produce pulses of various widths, spacing, over a wide range of repetition rates.

In practice, the actual timing of each pulse 110b or group 110a is slightly modified in time to synchronize the output to other components of the laser processing system. This modification in time results in phase jitter. The maximum amount of this phase jitter from one pulse 110b to the next pulse is typically less than 5%. Therefore, by way of example, the output repetition rate is specified to be 9.5 KHz to 31.5 KHz for nominal 10-30 KHz operation, or about 19 KHz to 52.5 KHz for nominal 20-50 KHz operation, or 19 KHz to 210 KHz for nominal 20-200 KHz operation.

As previously pointed out and shown in FIG. 4a, not all of the laser output pulses 130 are used to process the targets. The pulses to be used to process the targets are selected by the AOM modulator 116 external to the laser 102. Pulses that are not selected go into a beam dump in the beam box (not shown).

In some embodiments, a wavelength shifter 117, for instance a frequency doubler or tripler, may be used to produce a green or UV processing output. At least the '412 patent and the '896 application describe short wavelength processing and associated benefits in more detail.

Though “first pulse suppression” is a commonly practiced technique with pulsed lasers, it is noted herein that the first few triggered laser pulses are typically not used to process the targets. These first few pulses are intended to allow at least one of the laser 102 and the amplifier 111 to stabilize. Generally, a “free-running” mode locked pulse train, in normal operation, will not require added time for stabilizing. The number of unused pulses depends on when the laser 102 was last triggered and the system configuration.

In at least one embodiment, the amplifier 111 amplifies a selected output of the mode locked laser 102, a relatively small number of the available pulses 130,105. As pointed out above, the amplifier 111 may require a continuous pulse stream to remain in stable operation. As shown in FIG. 4a, the pulse picker 104 selects pulses at a predetermined repetition rate (for example at a rate in the range of 20 KHz to 50 KHz) and the trigger signal 101 and associated laser output controller elements 103, 104 adjusts the phase of the output pulses. By way of example, 25 MHz is again shown.

This method of pulse picking corresponding to FIG. 4a provides a method to set the phase of the laser pulses after the pulse picker 104, for example to within 1/25 MHz=40 ns jitter for a 25 MHz pulse train 130. By way of example, if a wafer positioning system translates the wafer at 150 mm/sec and a link to be processed has a width of 0.6 μm, the 40 ns jitter will correspond to about 1% of the link width. It may be desirable to position the center of a spot corresponding to the one or more pulses at a link center to within about 10% of a link width, or better. As such, the 40 ns jitter will correspond to about 10% of the desired target position.

Various embodiments relate to synchronizing laser processing output pulses with other system components. Suitable modifications or adjustments, for instance, adding constraints to motion profiles such that a first laser processing position in a constant velocity motion segment occurs at an appropriate time and in phase with a laser output as previously described.

The phase is set using the trigger control signal 101. Before the trigger signal 101 arrives, the pulse picker 104 is selecting every nth pulse. After the trigger signal 101 arrives, the pulse picker 104 is again selecting every nth pulse but the phase of the pulses has changed. The phase can be adjusted one of two ways.

1) The phase can be adjusted by increasing the delay between two pulses at the time of the trigger signal 101 (i.e., FIG. 5c); and

2) The phase can be adjusted by decreasing the delay between two pulses at the time of the trigger signal 101 (i.e., FIG. 5b).

The second method is most preferred; the phase should be adjusted by decreasing the delay between two pulses at the time of the trigger signal 101.

FIGS. 5a, 5b and 5c show timing diagrams corresponding to the system of FIG. 4a. The exemplary figures further clarify the desired method for adjusting the phase. In these diagrams, the pulse picker 104 is shown selecting every 10th pulse 135 from the pulse train 130. In the actual system, the pulse picker 104 will be selecting one pulse out of every 500 to 1250 pulses in order to reduce the repetition rate from 25 MHz to within a typical, non-limiting range of 20 KHz to 50 KHz.

Adjusting the phase by reducing the time between pulses is most preferred because it allows a user or designer to effectively control the timing for every laser pulse. Control of every laser pulse is done by setting the laser repetition rate to be slightly less than the repetition rate desired by the system and then sending a trigger pulse 101 for every desired laser pulse. For example, the laser repetition rate can be set to 20 KHz ( 1/20 KHz=50 μs) by setting the pulse picker 104 to select every 1250^{th} pulse. Then, the laser trigger signal 101 can request laser pulses at a 30 KHz rate ( 1/30 KHz=33.3 . . . μs) by sending trigger signal pulses every 33.3 . . . μs. This causes the pulse picker control logic to reset with every trigger pulse 101 and for the pulse picker 104 to emit pulses at a 30 KHz rate.

“Pulse Picking”—Pulse Train Without Amplification After Pulse Picking

FIG. 6a illustrates synchronization in accordance with one embodiment of the present invention. By way of example, a mode locked laser 202 having a repetition rate of 25 MHz (105, 130 in FIG. 6b) is shown. However, other repetition rates may be used—for example 68 MHz. A pulse picker 204 simply selects pulses on demand. The relatively simple arrangement may be best in an application with a laser system without an amplifier. Alternatively, this “pulse on demand” approach may also be utilized in a system with an optional amplifier 211 between the laser 202 and the pulse picker 204. An optional AOM 216 may be utilized for energy control. In any case, if no pulses are requested by producing a trigger signal 201, then no laser pulses are selected by the pulse picker 204 and no pulses are emitted from the pulse picker 204. FIG. 6b shows the corresponding timing diagram.

Additional Embodiment—Use of Commercial Laser

Various embodiments of the invention may be carried out with commercial laser systems that are adaptable for practicing various features and combination of features described herein. A picosecond laser produced by Lumera Laser GmbH was modified to carry out operation substantially as shown in FIG. 4a with an option called “Rapid.” A trigger signal 101 is provided to the laser system and beam splitter/detector combination 106 provide a control signal and time-based signal. The Lumera system called also includes a user interface that allows access to the pulse picker controller 103, and thereby provides for user control over a number of pulse parameters.

Output Energy Control

In at least one embodiment, the output energy may be precisely controlled over a wide dynamic range. Preferably, the energy control will be operable over a wide dynamic range and be usable for both alignment and laser processing operations. The AOM 116,216 of FIGS. 4a and 6a may be used to precisely control the pulse power or energy over a wide dynamic range. In typical operation, the energy emitted at the output 120,220 may be in a range from less than 1 nanojoule, for example 100 picojoules, to several microjoules.

In a preferred arrangement, as shown in the above-noted co-pending U.S. patent application Ser. No. 11/317,047, a plurality of bulk attenuators are used so that the RF equipment may be operated with a high signal-to-noise ratio. Such an arrangement is particularly useful for precise ablation of target materials with short or ultra-short pulses, notwithstanding a possible requirement for subsequent dispersion correction if femtosecond pulses are used. Applications may include picosecond link processing, picosecond or femtosecond laser marking, as well as conventional laser processing with nanosecond or longer pulses.

In accordance with the present invention, other non-conventional laser sources may also be provided for improved micromachining. A mode-locked diode laser having a semiconductor saturable absorber mirror may provide for picosecond width pulses at GHz repetition rates. High repetition rate, passively q-switched micro-lasers that produce sub-nanosecond outputs are also available.

Though specific emphasis herein is directed to “free-running” sources, it is possible to operate active sources with a controller to emulate free-running operation, perhaps for improved stability, and utilize embodiments of the present invention to controllably select pulses for laser processing.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A laser-based material processing method comprising:
providing a pulsed laser source for generating a set of laser pulses;
controllably selecting a subset of pulses from the set of laser pulses at a position beyond the laser source to obtain a pulsed laser output;
synchronizing the pulsed laser output with relative movement of target material; and
selectively delivering at least a portion of the synchronized pulsed laser output to the target material as a laser material processing output to process the target material.

2. The method as claimed in claim 1, wherein the step of controllably selecting includes the step of receiving a control signal.

3. The method as claimed in claim 2, wherein the step of synchronizing includes the step of setting phase of the pulsed laser output in response to at least the control signal to synchronize the relative movement of the target material with the pulsed laser output that is used to process the target material.

4. The method as claimed in claim 3, wherein the step of controllably selecting includes the step of receiving a time-based input related to a pulse of the set.

5. The method as claimed in claim 4, wherein the step of setting includes the step of producing, in response to both the control signal and the time-based input, a pulse selection signal to at least initiate selection of the subset of pulses.

6. The method as claimed in claim 4, wherein temporal position of the pulse in the set is independent of the relative movement.

7. The method as claimed in claim 1, wherein the set of laser pulses is a high repetition rate laser pulse train, and wherein during the step of controllably selecting, pulses are selected from the high repetition rate laser pulse train to produce laser output pulses having a reduced repetition rate and a desired phase.

8. The method as claimed in claim 7, wherein the step of selectively delivering includes the step of selecting a portion of the laser output pulses to produce the processing output.

9. The method as claimed in claim 3, wherein the step of setting produces a subset of substantially periodic pulses that are phase-shifted relative to at least some output pulses that precede the control signal.

10. The method as claimed in claim 9, wherein the step of setting introduces a constant delay between phase-shifted pulses, to within an approximate phase jitter.

11. The method as claimed in claim 9, wherein the step of setting includes the step of substantially minimizing a delay between a pulse that immediately precedes the control signal and a first phase-shifted pulse of a subset of output pulses that immediately follows the control signal.

12. The method as claimed in claim 3, wherein the target material is a target structure and wherein the processing includes removing the structure with a group of pulses of the processing output.

13. The method as claimed in claim 12, wherein the step of setting causes the processing output to impinge a region which is centered within 10% of a center of the target structure during motion of the pulsed laser output relative to the target structure, whereby an improvement in at least one of laser processing throughput and precision results relative to a non-phase shifted laser material processing output.

14. The method as claimed in claim 1 further comprising amplifying a portion of the set of laser pulses to produce a series of amplified laser output pulses.

15. The method as claimed in claim 14 further comprising selecting at least a portion of the amplified laser output pulses to produce laser material processing pulses and directing the selected laser material processing pulses to the target material.

16. A laser-based material processing system comprising:
a pulsed laser source for generating a set of laser pulses;
a laser output control that controllably selects a subset of pulses from the set of laser pulses at a position beyond the laser source to obtain a pulsed laser output;
a mechanism for synchronizing the pulsed laser output with relative movement of target material;
a beam delivery and focusing subsystem for delivering at least a portion of the synchronized pulsed laser output to the target material as a laser material processing output to process the target material; and
a positioning subsystem for moving the target material relative to the pulsed laser output.

17. The system as claimed in claim 16, wherein the system is a high-speed, laser-based micromachining system for modifying the target material.

18. The system as claimed in claim 16, wherein the target material is a target structure and wherein the processing includes at least partially removing the structure.

19. The system as claimed in claim 16, wherein the laser output control sets a phase of the pulsed laser output in response to at least a control signal.

20. The system as claimed in claim 19, wherein the laser output control receives the control signal and a time-based input related to a pulse of the set and, in response to the control signal and the time-based input, at least initiates selection of the subset of the set.

21. The system as claimed in claim 20 further comprising a detector which detects pulses generated by the laser source to obtain the time-based input.

22. The system as claimed in claim 16 further comprising an optical amplifier for amplifying pulses selected by the laser output control, and an output modulator for selectively directing amplified pulses to the beam delivery and focusing subsystem.

23. The system as claimed in claim 22 further comprising a wavelength shifter that receives the amplified pulses, the amplified pulses having a first wavelength, and shifts the first wavelength to a shorter wavelength.

24. The system as claimed in claim 23, wherein the first wavelength is about 1.064 microns and the shorter wavelength is about 0.532 microns.

25. The system as claimed in claim 16, wherein the laser source generates a substantially periodic pulse train having a MHz repetition rate, and the control selects a subset of the pulse train to obtain a reduced repetition rate.

26. The system as claimed in claim 25, wherein the reduced repetition rate is substantially less than the repetition rate of the pulse train.

27. The system as claimed in claim 26, wherein the reduced repetition rate is in a typical range of 20 KHz up to a predetermined rate that is sufficiently high to avoid substantially limiting throughput of the material processing system.

28. The system as claimed in claim 27, wherein the reduced repetition rate is in a typical range of about 20 KHz to 500 KHz.

29. The system as claimed in claim 25, wherein the control selects groups of pulses of up to about 200 pulses per group, each group being selected so that groups of output pulses occur at a repetition rate substantially less than the repetition rate of the pulse train.

30. The system as claimed in claim 29, wherein spacing between pulses within a group corresponds to the repetition rate of the pulse train.

31. The system as claimed in claim 29 further comprising an optical amplifier to amplify each selected group of pulses.

32. The system as claimed in claim 31 further comprising an output modulator to selectively direct at least one group of amplified pulses to the beam delivery and focusing subsystem.

33. The system as claimed in claim 16, wherein the pulsed laser source is a mode-locked solid state laser.

34. The system as claimed in claim 16, wherein the pulsed laser source is a mode-locked laser that generates pulses at a repetition rate of about 10 MHz-200 MHz.

35. The system as claimed in claim 16, wherein movement of the target material relative to a laser material processing output is about 8 nm/s to about 200 mm/s.

36. The system as claimed in claim 16, wherein the control includes an electro-optic or acousto-optic device.

37. The system as claimed in claim 22, wherein the output modulator selects a portion of the amplified pulses to be directed to the beam delivery and focusing subsystem.
